(19) United States
(12) Patent Application Publication
(10) Pub. No.: US 2015/0379748 A1
(43) Pub. Date: Dec. 31, 2015

(54) IMAGE GENERATING APPARATUS, IMAGE GENERATING METHOD AND COMPUTER READABLE RECORDING MEDIUM FOR RECORDING PROGRAM FOR GENERATING NEW IMAGE BY SYNTHESIZING A PLURALITY OF IMAGES

(71) Applicant: CASIO COMPUTER CO., LTD., Tokyo (JP)

(72) Inventors: Genki KUMAZAKI, Tokyo (JP); Takashi ONODA, Tokyo (JP); Kenji IWAMOTO, Tokyo (JP); Taku KOREKI, Tokyo (JP); Takeshi OKADA, Tokyo (JP)

(73) Assignee: CASIO COMPUTER CO., LTD., Tokyo (JP)

(21) Appl. No.: 14/747,785

(22) Filed: Jun. 23, 2015

(30) Foreign Application Priority Data
Jun. 30, 2014 (JP) 2014-134845
Sep. 22, 2014 (JP) 2014-193093
Mar. 23, 2015 (JP) 2015-059983

(51) Int. Cl. G06T 11/60

(52) U.S. Cl. CPC G06T 11/60

(57) ABSTRACT

An imaging apparatus includes an image acquiring unit, an image setting unit, an image selecting unit, and an image generating unit. The image acquiring unit acquires a plurality of images belonging to different groups. The image setting unit determines the number of images to be used for generation of a new image. The image selecting unit selects images of the number determined by the image setting unit from the plurality of images based on supplementary information of a plurality of images belonging to each of the different groups acquired by the image acquiring unit. The image generating unit generates a new image from the images selected by the image selecting unit.

### CROSS-REFERENCE TO RELATED APPLICATIONS

This application is based upon and claims the benefit of priority under 35 USC 119 of Japanese Patent Application No. 2014-193093 filed on Sep. 22, 2014, the entire disclosure of which is incorporated herein by reference in its entirety for all purposes.

### BACKGROUND OF THE INVENTION

1. Field of the Invention

The present invention relates to an image generating apparatus, an image generating method and a computer readable recording medium for recording a program for generating a new image by synthesizing a plurality of images.

2. Description of the Related Art

As a conventional technology, Japanese Patent Application Laid-Open Publication No. 2000-43363 published on Feb. 15, 2000 discloses generating an image by synthesizing images of a predetermined number from a plurality images.

### SUMMARY OF THE INVENTION

According to an embodiment of the present invention, an image generating apparatus is provided. The image generating apparatus includes an image acquiring section configured to acquire a plurality of images belonging to different groups, an image number determining section configured to determine the number of images to be used for generation of a new image, an image selecting section configured to select images of the number determined by the image number determining section from the plurality of images belonging to the different groups acquired by the image acquiring section based on supplementary information of the plurality of images acquired by the image acquiring section, and a generating section configured to generate a new image from a plurality of images selected by the image selecting section.

According to an embodiment of the present invention, an image generating method is provided. The image generating method includes an image acquiring step of acquiring a plurality of images belonging to different groups, an image number determining step of determining the number of images to be used for generation of a new image, an image selecting step of selecting images of the number determined at the image number determining step from the plurality of images belonging to the different groups acquired at the image acquiring step based on supplementary information of the plurality of images acquired at the image acquiring step, and a generating step of generating a new image from a plurality of images selected at the image selecting step.

According to an embodiment of the present invention, non-transitory computer-readable recording medium for recording a program readable by a computer is provided. The program controls the computer to function as an image acquiring section configured to acquire a plurality of images belonging to different groups, an image number determining section configured to determine the number of images to be used for generation of a new image, an image selecting section configured to select images of the number determined by the image number determining section from the plurality of images belonging to the different groups acquired by the image acquiring section based on supplementary information of the plurality of images acquired by the image acquiring section, and a generating section configured to generate a new image from a plurality of images selected by the image selecting section.

### BRIEF DESCRIPTION OF THE DRAWINGS

The present invention will more sufficiently be understood by the following detailed description and the accompanying drawings, which are, however, exclusively for explanation and do not limit the scope of the present invention.

Here:

FIG. 1 is a block diagram showing a hardware configuration of an imaging apparatus according to an embodiment of the present invention.

FIG. 2 is a schematic diagram for illustrating new images generated by the embodiment.

FIG. 3 is a functional block diagram showing a functional configuration of the imaging apparatus of FIG. 1 for performing an image generation process.

FIG. 4 is a flow chart for explaining the image generation process performed by the imaging apparatus of FIG. 1 having the functional configuration of FIG. 3.

FIG. 5 is a flow chart for explaining an image generation process according to a second embodiment of the present invention.

FIG. 6 is a functional block diagram showing a functional configuration for performing a third image generation process.

FIG. 7 is a flow chart for explaining an image generation process according to a third embodiment of the present invention.

FIG. 8 is a flow chart for explaining an image generation process according to a fourth embodiment of the present invention.

FIG. 9 is a flow chart for explaining an image selection process according to a fifth embodiment of the present invention.

### DETAILED DESCRIPTION OF THE PREFERRED EMBODIMENT

Hereinafter, embodiments of the present invention will be described with reference to the accompanying drawings.

### First Embodiment

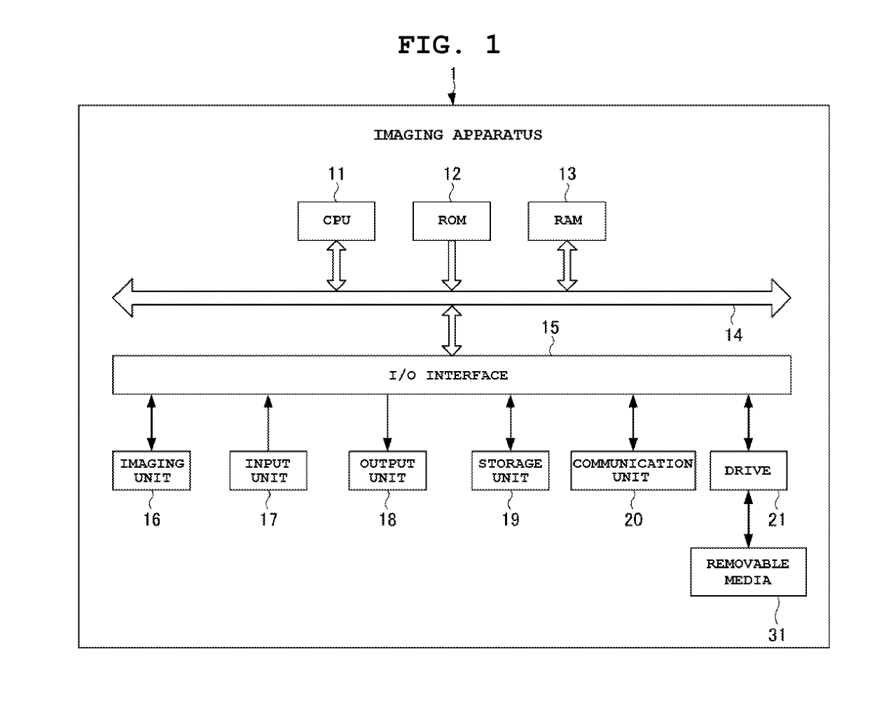

FIG. 1 is a block diagram showing a hardware configuration of an imaging apparatus according to an embodiment of the present invention.

For example, the imaging apparatus 1 is realized by a digital camera.

The imaging apparatus 1 includes a CPU (Central Processing Unit) 11, a ROM (Read Only Memory) 12, a RAM (Random Access Memory) 13, a bus 14, an I/O interface 15, an imaging unit 16, an input unit 17, an output unit 18, a storage unit 19, a communication unit 20, and a drive 21.

The CPU 11 executes various processes according to programs stored in the ROM 12 or loaded in the RAM 13 from the storage unit 19.

In the RAM 13, there are stored data necessary for the CPU 11 to execute various processes, and the like.

The CPU 11, the ROM 12 and the RAM 13 are connected to each other via the bus 14. The I/O interface 15 is also connected to the bus 14. The imaging unit 16, the input unit 17, the output unit 18, the storage unit 19, the communication unit 20, and the drive 21 are connected to the I/O interface 15.

The imaging unit 16 includes an optical lens unit and an image sensor (not shown in the drawing).

The optical lens unit includes lenses for collecting light to photograph a subject, for example, a focus lens, a zoom lens, and the like.

The focus lens forms an image of a subject on a light-receiving surface of the image sensor. The zoom lens freely changes the focal length within a predetermined range.

Further, the optical lens unit is provided with a peripheral circuit to adjust setting parameters such as focusing, exposure, white balancing, and the like, as necessary.

The image sensor includes a photoelectric conversion element, an AFE (Analog Front End), and the like. The photoelectric conversion element includes a CMOS

(Complementary Metal Oxide Semiconductor) type photoelectric conversion element, for example. A subject's image is input to the photoelectric conversion element from the optical lens unit. The photoelectric conversion element performs photoelectric conversion (image capturing) of the subject's image and accumulates image signals for a predetermined period of time. The photoelectric conversion element provides the AFE with the accumulated image signals sequentially.

The AFE performs various signal processing operations such as A/D (Analog/Digital) conversion on the analog image signals. Digital signals are generated by the signal processing operations and output as output signals of the imaging unit 16.

The output signals of the imaging unit 16 are hereinafter referred to as “data of a captured image”. The data of the captured image is supplied to the CPU 11, an image processing unit (not shown in the drawing), or the like.

The input unit 17 includes various buttons and a variety of information is input via the input unit 17 in response to a user's operations.

The output unit 18 includes a display device, a speaker, or the like, and outputs images or voices.

The storage unit 19 includes a hard disk, a DRAM (Dynamic Random Access Memory), or the like and various image data is stored in the storage unit 19.

The communication unit 20 controls communication with different devices (not shown in the drawing) via a network such as Internet.

A removable media 31 including a magnetic disk, an optical disk, a magneto-optical disc, a semiconductor memory, or the like, is mounted on the drive 21. A program read out from the removable media 31 by the drive 21 is installed in the storage unit 19 as necessary. Similarly to the storage unit 19, the removable media 31 stores various data such as the image data stored in the storage unit 19.

The imaging apparatus 1 configured as described above selects images of a plurality of images automatically and executes image processing for the selected images to generate one new image.

Now, new images generated according to the present embodiment are described.

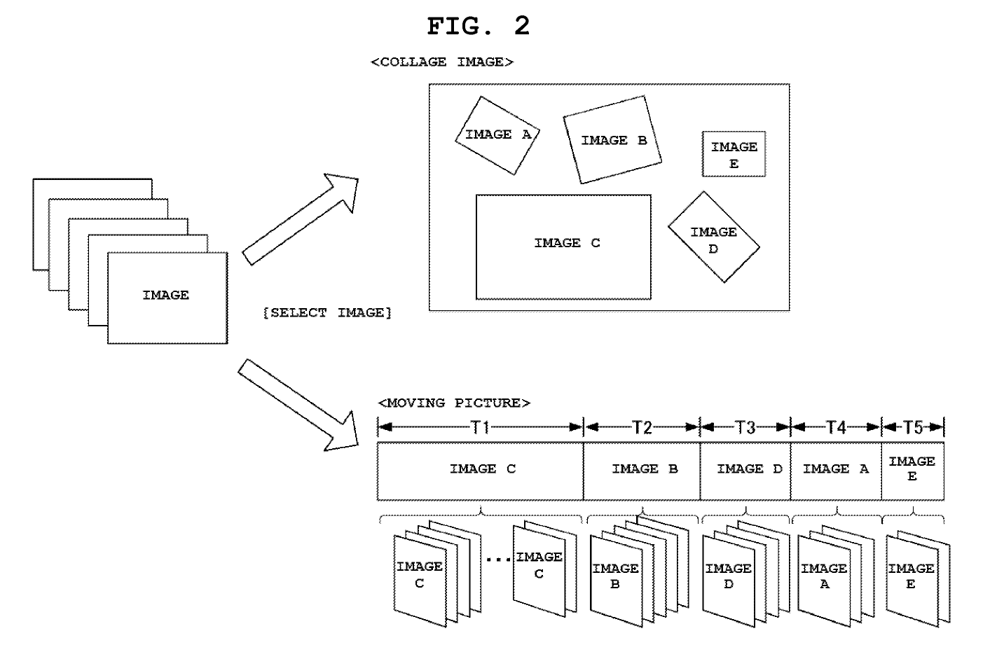

FIG. 2 is a schematic diagram for illustrating new images generated by the embodiment.

In the present embodiment, as shown in FIG. 2, two kinds of images are generated as the new images. One of the two kinds of images is an image in which a plurality of selected images are assembled by synthesizing the selected images (hereinafter, referred to as a “composite image”) and the other of the two kinds of images is a moving picture generated by using a plurality of selected images as frame images.

Further, in the present embodiment, a result of scoring an image is used as an evaluation of the image and the evaluation is used as one of criteria for selection of the image.

According to the present embodiment, the composite image is an image generated by assembling the plurality of images by casually cutting and pasting them, which is a so-called collage image. For the collage image, the plurality of images are disposed at different arrangements including different sizes, angles and positions in one frame. An area in which an image is to be disposed and a size of the image may be determined beforehand or set according to criteria for selection of the image every time.

In the case of setting an area and a size for an image according to the criteria for selection of the image every time and the selected image has a score, the size and/or the placement of the image are changed according to the score. More specifically, in the case that images A to E are selected and the image C, the image B, the image A, the image D and the image E are scored in descending order, an image of a higher score is disposed in a place easier to view or has a bigger size, for example.

The moving picture is a digest moving picture generated by arranging and connecting the plurality of selected images as frame images so that the sum of time allocated to the plurality of images is a set total playback time of the moving picture. More specifically, a part of the playback time of the moving picture is allocated to one of the plurality of selected images and the image is repeated by the number of frames corresponding to the allocated time. Each of the remaining images is repeated by the number of frames corresponding to time allocated to the image. The plurality of images are connected to form one digest moving picture.

In the case that the selected image has a score, an order and/or a length of time of playback of the image is determined according to the score. More specifically, similarly to the collage image, in the case that images A to E are selected and the image C, the image B, the image A, the image D and the image E are scored in descending order, the higher score an image has, the longer a time section of the total playback time of the moving picture allocated to the image is (for example, a time period T1 which is the longest one in the total playback time is allocated to the image C, a secondly long time period T2 is allocated to the image B, a thirdly long time period T3 is allocated to the image A, a fourthly long time period T4 is allocated to the image D, and a fifthly long time period T5 is allocated to the image E) and the faster the order of display of the image is.

As described above, the imaging apparatus 1 generates a new image (a collage image or a digest moving picture) and reduces a user's burden of selecting images from a plurality of images. Further, the imaging apparatus 1 can generate a new image from which the user gets great satisfaction.

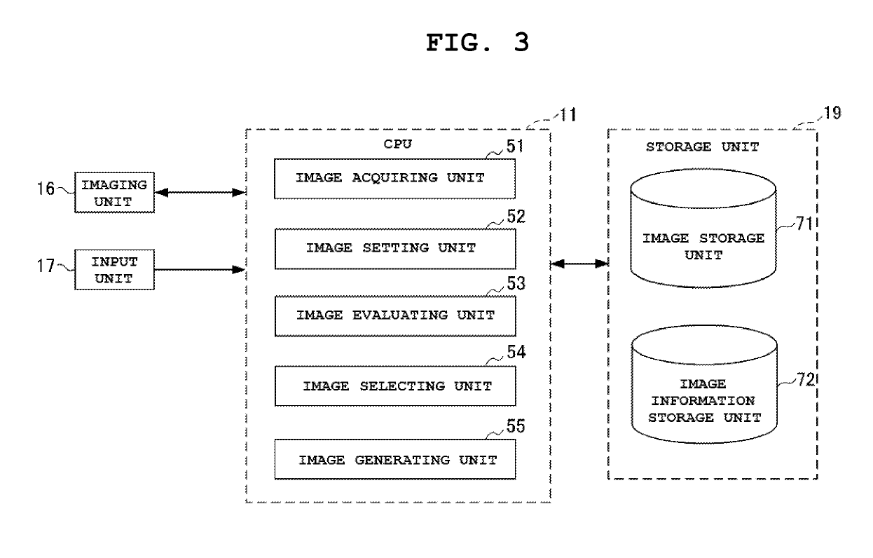

FIG. 3 is a functional block diagram showing a functional configuration of the imaging apparatus 1 for performing an image generation process.

The image generation process as used herein means a series of actions taken in order to select images scoring high from a plurality of images and synthesize the selected images. The image generation process according to the present embodiment generates a collage image which is one piece of composite image by synthesizing selected multiple images.

In the case of executing the image generation process, an image acquiring unit 51, an image setting unit 52, an image evaluating unit 53, an image selecting unit 54, and an image generating unit 55 of the CPU 11 function.

In an area of the storage unit 19, an image storage unit 71 and an image information storage unit 72 are configured.

Image data is stored in the image storage unit 71. Supplementary information such as a shooting date or shooting information is written in a predetermined information area of image data of each image (in the case of a still picture, EXIF (Exchangeable image file format) area).

Here, the “shooting information” means information about conditions when shooting an image and/or the shot image and, for example, includes an image size, an aspect ratio, an exposure time, AF (Auto Focus), AE (Automatic Exposure), a scene determination result, a shooting mode, the number/size/position of detected faces, or the like.

In the image information storage unit 72, there are stored the number of images to be used for a composite image (hereinafter, referred to as “No. of images to be synthesized”) and information about a composite image to be generated such as arrangement of selected images in the composite image, a threshold of the score for determining whether or not to select an image, and the like (hereinafter, referred to as “image information”).

The image acquiring unit 51 acquires images from the imaging unit 16 or the outside and the acquired images are stored in the image storage unit 71.

Based on operations input to the input unit 17 by a user, the image setting unit 52 sets whether or not the user wants to use an image. In other words, the image setting unit 52 sets whether the image is an image wanted for use or an image unwanted for use. The setting information is added to the supplementary information of the image.

The image evaluating unit 53 performs evaluation of the acquired images. The image evaluating unit 53 evaluates an image by scoring the shooting information included in the supplementary information of the image. In the case that the score is high, there is a high possibility that the image will be selected because the image is evaluated high. On the other hand, in the case that the score is low, there is a low possibility that the image will be selected because the image is evaluated low. The image evaluating unit 53 allows the score to be stored in the supplementary information of the image.

More specifically, the image evaluating unit 53 evaluates an image in terms of whether or not the image is proper for display by using the shooting information of the image such as the image size, the aspect ratio, the exposure time, the AF (Auto Focus), the AE (Automatic Exposure), the scene determination result, the shooting mode, the number/size/position of detected faces, or the like. For example, in the case the image is determined to be proper for display based on the shooting information, the image evaluating unit 53 adds points to the score of the image. On the other hand, in the case the image is determined to be not proper for display based on the shooting information, the image evaluating unit 53 deducts points from the score of the image.

For the “image size”, the image evaluating unit 53 determines whether or not the size of the image corresponds to the full HD (High Definition) movie quality and determines the score. For example, in the case the size of the image does not correspond to the full HD movie quality, the image evaluating unit 53 deducts some points from the score of the image.

For the “aspect ratio”, the image evaluating unit 53 determines the score based on the difference between aspect ratios. For example, an image shot vertically is converted into a horizontal one. In the case that the converted image has blank spaces in the left and right sides, the image is regarded as unsuitable for display and the image evaluating unit 53 deducts some points from the score of the image.

For the “exposure time”, the image evaluating unit 53 determines the score based on an exposure time. For example, the longer the exposure time of an image is, the more points deducted from the score of the image. This is because there is a possibility that the image is blurred and the image is unsuitable for display.

For the “AF”, the image evaluating unit 53 determines the score based on whether or not an image is focused. For example, in the case that an image is out of focus, there is a possibility that the image is blurred and the image evaluating unit 53 deducts some points from the score of the image.

For the “AE”, the image evaluating unit 53 determines the score based on a degree of exposure. For example, in the case of underexposure or overexposure, the image evaluating unit 53 deducts some points from the score of the image.

For the “scene determination result”, the image evaluating unit 53 determines the score based on a determined scene. For example, in the case that a camera determines a frame as a special scene and shoots an image of the scene, the image evaluating unit 53 adds some points to the score of the image.

For the “shooting mode”, the image evaluating unit 53 determines the score based on a set shooting mode. For example, in the case that an image is shot in a shooting mode for performing special image processing, the image evaluating unit 53 adds some points to the score of the image.

For the “number/size/position of detected faces”, the score is determined according to tastes of the user and the image evaluating unit 53 determines the score based on the number of faces detected from an image, a ratio of the faces to the overall image, and/or importance of positions of the faces in the image. For example, in the case that the number of detected face(s) is high, the size of the face(s) is big and the face(s) are located near the center of the image, the image is regarded as important to the user and the image evaluating unit 53 adds some points to the score of the image.

The image selecting unit 54 performs selection of images to be used for image synthesis based on whether or not to use an image set by the image setting unit 52 and the evaluation by the image evaluating unit 53 in accordance with the number of images to be displayed from the image information stored in the image information storage unit 72.

More specifically, in the case the number of images to be displayed is five, the image selecting unit 54 excludes images set as unwanted for use and images scoring lower than a threshold from selection and then selects five images in descending order of the score.

Based on the arrangement of the selected images in one composite image from the image information stored in the image information storage unit 72, the image generating unit 55 disposes each image of the plurality of images selected by the image selecting unit 54 at a predetermined position in the composite image and synthesizes the plurality of images to generate a collage image as one piece of composite image.

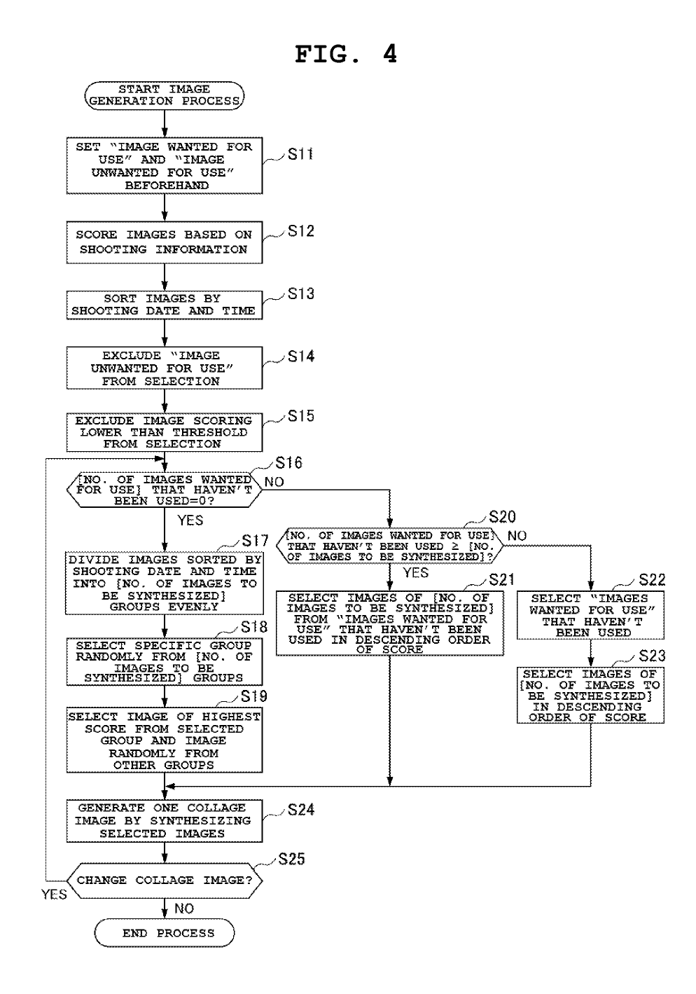

FIG. 4 is a flow chart for explaining the image generation process performed by the imaging apparatus 1 of FIG. 1 having the functional configuration of FIG. 3.

The image generation process is started by an operation to start the process input by the user to the input unit 17. Around the start of the image generation process, the image acquiring unit 51 acquires images from the imaging unit 16 or the outside and allows the acquired images to be stored in the image storage unit 71.

At Step S11, the image setting unit 52 performs setting of “images wanted for use” and “images unwanted for use” according to operations input by the user to the input unit 17 beforehand. The setting information is added to the supplementary information of the images.

At Step S12, the image evaluating unit 53 scores the images based on the shooting information of the images. More specifically, the image evaluating unit 53 evaluates images using the shooting information such as an image size, an aspect ratio, an exposure time, AF (Auto Focus), AE (Automatic Exposure), a scene determination result, a shooting mode, the number/size/position of detected faces, or the like, for example, in terms of whether or not each of the images is proper for display. As a result, the images are determined to score high or low and the image evaluating unit 53 allows the score of an image to be stored in the supplementary information of the image.

At Step S13, the image selecting unit 54 sorts the images referring to the supplementary information of each image in by shooting date and time.

At Step S14, the image selecting unit 54 excludes the “images unwanted for use” set by the image setting unit 52 from selection. More specifically, the image selecting unit 54 refers to the supplementary information of each image and excludes the images which the user does not want to use from selection.

At Step S15, the image selecting unit 54 excludes images scoring lower than a threshold from selection. More specifically, referring to the supplementary information of each image, the image selecting unit 54 determines whether or not the image scores lower than the threshold and excludes images scoring lower than the threshold from selection.

At Step S16, the image selecting unit 54 determines whether or not the number of “images wanted for use” that have not been used (displayed) despite change of the collage image and have not been used for synthesis yet is zero (0). The image selecting unit 54 refers to the supplementary information of each image to count the number of images wanted for use and determines whether or not the number is zero.

In the case that the number of “images wanted for use” that have not been used is not zero, the determination at Step 16 is “NO” and the process proceeds to Step S20. Step S20 and subsequent steps will be described later.

In the case that the number of “images wanted for use” that have not been used is zero, the determination at Step 16 is “YES” and the process proceeds to Step S17.

The image generation process includes a plurality of subsequent steps of selecting the “images wanted for use” that have not been used by priority.

At Step S17, the image selecting unit 54 divides the images sorted by shooting date and time into groups of [No. of images to be synthesized] evenly.

At Step S18, the image selecting unit 54 randomly selects a group from the groups of [No. of images to be synthesized].

At Step S19, the image selecting unit 54 selects an image scoring the highest from the selected group and randomly selects images from the other groups. In other words, the image selecting unit 54 changes criteria for selection by selecting an image from a specific group by the score and randomly selecting images from the other groups. Then, the process proceeds to Step S24. Step S24 will be described later.

At Step S20, the image selecting unit 54 determines [No. of images wanted for use] that have not been used is greater than or equal to [No. of images to be synthesized].

In the case that [No. of images wanted for use] that have not been used is greater than or equal to [No. of images to be synthesized], the determination at Step S20 is “YES” and the process proceeds to Step S21.

At Step S21, the image selecting unit 54 selects images of [No. of images to be synthesized] from the “images wanted for use” that have not been used in descending order of the score. Then, the process proceeds to Step S24.

On the other hand, in the case that [No. of images wanted for use] that have not been used is smaller than [No. of images to be synthesized], the determination at Step S20 is “NO” and the process proceeds to Step S22.

At Step S22, the image selecting unit 54 selects all of the “images wanted for use” that have not been used.

At Step S23, the image selecting unit 54 selects images of [No. of images to be synthesized] in descending order of the score. More specifically, the image selecting unit 54 selects images of {[No. of images to be synthesized]-[No. of images wanted for use] that have not been used} from the remaining images in descending order of the score.

At Step S24, the image generating unit 55 generates a collage image which is one piece of composite image by synthesizing the images selected by the image selecting unit 54.

More specifically, in the example of FIG. 2 where the images A to E are selected and the image C, the image B, the image A, the image D and the image E are scored in descending order, an image of a higher score is disposed in a place easier to view or has a bigger size than ones of lower scores.

Then, the image generating unit 55 allows the generated collage image to be stored in the image storage unit 71.

At Step S25, the image selecting unit 54 determines whether or not an instruction to change the collage image is input from the input unit 17 or the like.

In the case that there is the instruction to change the collage image, the determination at Step S25 is “YES” and the process returns to Step S16.

In the case that there is no instruction to change the collage image, the determination at Step S25 is “NO” and the process is ended.

Thus, the imaging apparatus 1 selects “images wanted for use” that have not been used by priority in the case that the collage image is changed. Further, by grouping the images by shooting date and time, the imaging apparatus 1 selects images in time sequence evenly. In addition, the imaging apparatus 1 changes methods for automatically selecting images according to groups.

Often, just with changing images randomly, the user's satisfaction is not improved. The imaging apparatus 1 of the present embodiment can improve completeness of image synthesis because it maintains randomness while an image which the user expects can be easily made by automatic image selection.

Although the embodiment described above is configured to dispose an image of a higher score in a place easier to view or enlarge the size of the image than ones of lower scores, the present invention is not limited to this configuration. For example, another embodiment of the present invention may be configured to add to an image of a higher score ornamental special effects such as making colors of the image look remarkable.

### Second Embodiment

The image generation process according to the above described embodiment is configured to generate a collage image as one piece of composite image from a plurality of selected images. The second embodiment of the present invention generates one digest moving picture by connecting a plurality of selected images.

In the second embodiment, a hardware configuration and a functional configuration for performing an image generation process are the same as those of the first embodiment.

Therefore, descriptions of the configurations of the second embodiment are omitted. Since a digest moving picture is generated by the second embodiment while a collage image is generated by the first embodiment, an image generating process performed by the image generating unit 55 and criteria of image selection of the second embodiment are different from those of the first embodiment. Thus, the differences are explained below in detail with respect to a flow chart describing the image generation process of the second embodiment.

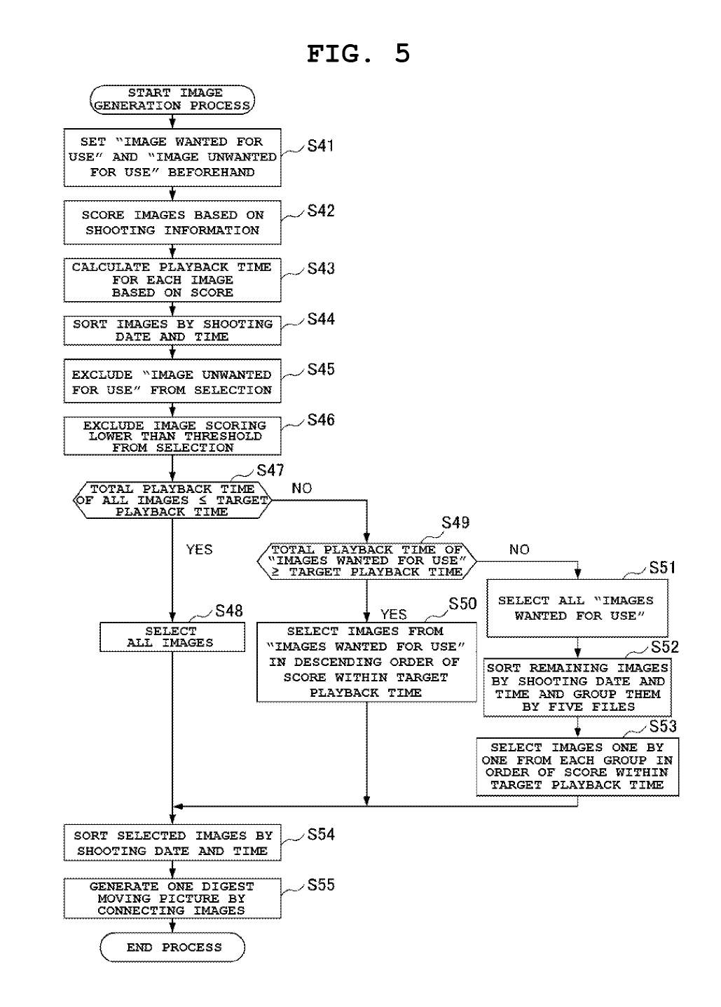

FIG. 5 is a flow chart for explaining an image generation process according to the second embodiment of the present invention.

The image generation process is started by an operation to start the process input by a user to the input unit 17. Around the start of the image generation process, the image acquiring unit 51 acquires images from the imaging unit 16 or the outside and allows the acquired images to be stored in the image storage unit 71.

At Step S41, the image setting unit 52 performs setting of “images wanted for use” and “images unwanted for use” according to operations input by the user to the input unit 17 beforehand. The setting information is added to the supplementary information of the images.

At Step S42, the image evaluating unit 53 scores the images based on the shooting information of the images. More specifically, the image evaluating unit 53 evaluates images using the shooting information such as an image size, an aspect ratio, an exposure time, AF (Auto Focus), AE (Automatic Exposure), a scene determination result, a shooting mode, the number/size/position of detected faces, or the like, for example, in terms of whether or not each of the images is proper for display. As a result, the images are determined to score high or low and the image evaluating unit 53 allows the score of an image to be stored in the supplementary information of the image.

At Step S43, the image evaluating unit 53 calculates playback time for each image based on the score of the image. More specifically, the image evaluating unit 53 calculates longer playback time for an image scoring higher.

At Step S44, the image selecting unit 54 sorts the images referring to the supplementary information of each image in by shooting date and time.

At Step S45, the image selecting unit 54 excludes the “images unwanted for use” set by the image setting unit 52 from selection. More specifically, the image selecting unit 54 refers to the supplementary information of each image and excludes the images which the user does not want to use from selection.

At Step S46, the image selecting unit 54 excludes images scoring lower than a threshold from selection. More specifically, referring to the supplementary information of each image, the image selecting unit 54 determines whether or not the image scores lower than the threshold and excludes images scoring lower than the threshold from selection.

At Step S47, the image selecting unit 54 determines whether or not the total playback time of all the images is shorter than or equal to a target playback time stored in the image information storage unit 72.

In the case that the total playback time of all the images is shorter than or equal to the target playback time, the determination at Step S47 is “YES” and the process proceeds to Step S48.

At Step S48, the image selecting unit 54 selects all the images. In other words, the image selecting unit 54 selects every image except the “images unwanted for use” and the images scoring lower than the threshold. Then, the process proceeds to Step S54. Step S54 and subsequent steps will be described later.

On the other hand, in the case that the total playback time of all the images is longer than the target playback time, the determination at Step S47 is “NO” and the process proceeds to Step S49.

At Step S49, the image selecting unit 54 determines whether or not the total playback time of the “images wanted for use” is longer than or equal to the target playback time.

In the case that the total playback time of the “images wanted for use” is longer than or equal to the target playback time, the determination at Step 49 is “YES” and the process proceeds to Step S50.

At Step S50, the image selecting unit 54 selects images from the “images wanted for use” in descending order of the score within the target playback time. Then, the process proceeds to Step S54.

On the other hand, in the case that the total playback time of the “images wanted for use” is shorter than the target playback time, the determination at Step 49 is “NO” and the process proceeds to Step S51.

At Step S51, the image selecting unit 54 selects all of the “images wanted for use”.

At Step S52, the image selecting unit 54 sorts the remaining images by shooting date and time and groups them by five files. Further, although the number of files belonging to each group is five in the present embodiment, the number of files can be varied according to the number of images of an image set to be grouped. More specifically, the number of necessary files of images changes according to a length of movie set by the user. For example, a set of images of one hundred or less can be grouped by five files and a set of images of more than one hundred can be grouped by ten files. Further, it may be desirable to handle images of less than five files resulting from the grouping as one group from which any image can be selected.

At Step S53, the image selecting unit 54 selects images one by one from each group in descending order of the score within the target playback time.

At Step S54, the image selecting unit 54 sorts the selected images referring to the supplementary information of the images in by shooting date and time.

At Step S55, the image generating unit 55 generates one digest moving picture by connecting each of the images selected and sorted by shooting date and time by the selecting unit 54 for a playback time of the image. In other words, the image generating unit 55 connects each of the selected images sequentially by frames of the number corresponding to the playback time calculated for the image to generate a digest moving picture. More specifically, in the case of the example shown in FIG. 2 where the images A to E are selected and the image C, the image B, the image A, the image D and the image E are scored in descending order, the higher score an image has, the longer a time section of the total playback time allocated to the image is (for example, a time period T1 which is the longest one in the total playback time is allocated to the image C, a secondly long time period T2 is allocated to the image B, a thirdly long time period T3 is allocated to the image A, a fourthly long time period T4 is allocated to the image D, and a fifthly long time period T5 is allocated to the image E) and the faster the order of display of the image is.

Further, a special effect such as transition, panning or zooming may be applied between the selected images. According to the score of each image, whether or not to apply the special effect to the digest moving picture can be decided.

For example, in the case that the score is low (i.e. playback time of a still picture is short), no special effect is applied between images. On the other hand, in the case that the score is high (i.e. playback time of a still picture is long), a special effect is applied between images.

Further, according to the scores of the images included in the digest moving picture, the kinds of special effects between the images can be changed.

In addition, a digest moving picture can be formed from a combination of still and moving pictures or a combination of moving pictures as well as from still pictures. In the case of using moving pictures, the image evaluating unit 53 evaluates the moving pictures in a similar way to evaluating still pictures and scores the moving pictures to determine playback time.

After that, the image generation process is ended.

The imaging apparatus 1 of the embodiments of the present invention can generate a digest moving picture from which the user gets great satisfaction by just a small number of operations because the imaging apparatus 1 scores images based on shooting information, selects images which the user prefers by priority, automatically selects images to use according to scores and/or shooting date and time, or changes playback time or special effects according to the scores of the images. Further, it is possible to reduce the user's burden of selecting images from a plurality of images to generate a digest moving picture.

According to the present embodiment, a digest moving picture is generated based on the target playback time stored in the image information storage unit 72. The target playback time can be set freely by the user in advance, for example, to one minute or five minutes.

Further, according to the present embodiment, the higher the score and evaluation of an image is, the longer playback time is and the faster the order of display of the image is.

However, the present invention is not limited to this embodiment. According to another embodiment, an image scoring high is displayed in a time slot of peak view (for example, around the middle of the total playback time) or displayed a plurality of times.

### Third Embodiment

According to a third embodiment of the present invention, a collage image is formed based on images representing ones selected from groups of images divided by a predetermined time period (hereinafter, referred to as “representative images”). In addition, in the present embodiment, a layout for defining a size and a position of each of images for forming a collage image is selected from a plurality of layouts. At least one of the size and position of each of the representative images forming a collage image is different between the plurality of layouts.

Further, with respect to the present embodiment, descriptions of features common to the above described embodiments (the hardware configuration and the functional configuration for executing the image generation process) are omitted.

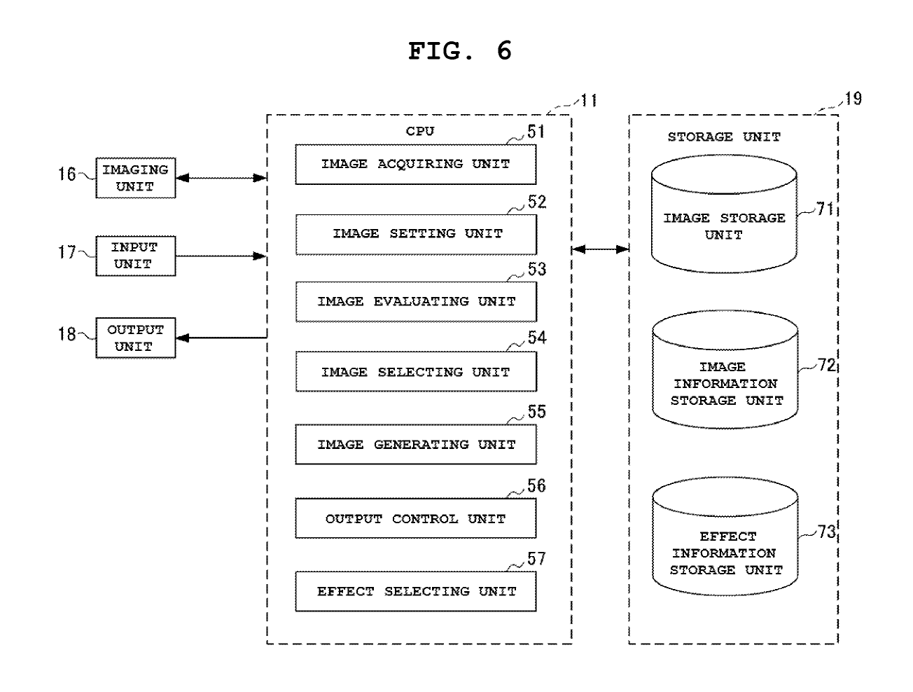

FIG. 6 is a functional block diagram showing a functional configuration for performing an image generation process according to the third embodiment.

In order to perform the image generation process, an output control unit 56 and an effect selecting unit 57 of the

CPU 11 function in addition to the image acquiring unit 51, the image setting unit 52, the image evaluating unit 53, the image selecting unit 54, and the image generating unit 55, as shown in FIG. 6.

Further, in addition to the image storage unit 71 and the image information storage unit 72, an effect information storage unit 73 is configured in an area of the storage unit 19.

In the effect information storage unit 73, there is stored information of layouts (ten kinds of layouts in the present embodiment), each of which illustrates sizes, arrangements and/or effects of images included in a collage image.

The image setting unit 52 performs setting of “favorite” images. The setting of favorite images is performed for each of the images stored in the image storage unit 71 by a user through the input unit 17. The image setting unit 52 sets the images to [FAVORITE], [UNFAVORITE] or [OTHERS]. The images set to [FAVORITE] are scored high or easy to be selected as representative images. The user does not want the images set to [UNFAVORITE] to be selected as representative images. The setting of favorite images is stored in the image information storage unit 72.

Further, the image setting unit 52 performs setting of a period of time for selecting images which will be used for a collage image. In the present embodiment, the image setting unit 52 sets a date selected by an operation input by the user to the input unit 17 as the period time for selecting images. Further, the image setting unit 52 may be configured to set the period of time for selecting images in hours, weeks or months. Alternatively, the image setting unit 52 may be configured to set the period of time for selecting images to a plurality of days, a plurality of weeks, a plurality of months, a combination of different time units (for example, a combination of days and weeks), or their combinations.

Further, the image setting unit 52 sets the number of images to use for a collage image by an operation input by the user to the input unit 17.

The image evaluating unit 53 evaluates every group of images divided by hours based on shooting information or the like similarly with the criteria for evaluation of the above described embodiments. For example, the image evaluating unit 53 evaluates images belonging to individual groups divided by predetermined time periods (for example, from 6 to 9 o′clock, from 10 to 13 o′clock, from 14 to 17 o′clock, from 17 to 20 o′clock, and the like) of a set date. Similarly with the embodiments above described, the images are scored for evaluation. The evaluation is further based on information of the favorite images set by the image setting unit 52. More specifically, the evaluation of an image is performed by adding some points to the score of the image which is given based on the shooting information in the case that the image is set to [FAVORITE], adding no point to the score in the case that the image is set to [OTHERS], and subtracting some points from the score in the case the image is set to [UNFAVORITE] so that the image is excluded from selection. Finally, images of scoring high are regarded as those receiving favorable evaluation.

The image selecting unit 54 selects a representative image from every group based on the evaluation performed by the image evaluating unit 53. In the present embodiment, the image selecting unit 54 selects an image having the highest score of a group to which the images belongs as a representative image of the group.

The output control unit 56 controls the output unit 18 to display the selected representative images and/or selectable layout candidates (in the present embodiment, then kinds of layout candidates).

The effect selecting unit 57 selects one of the layouts stored in the effect information storage unit 73 based on an instruction of the user. Further, the effect selecting unit 57 may select a layout automatically according to setting or properties of selected images.

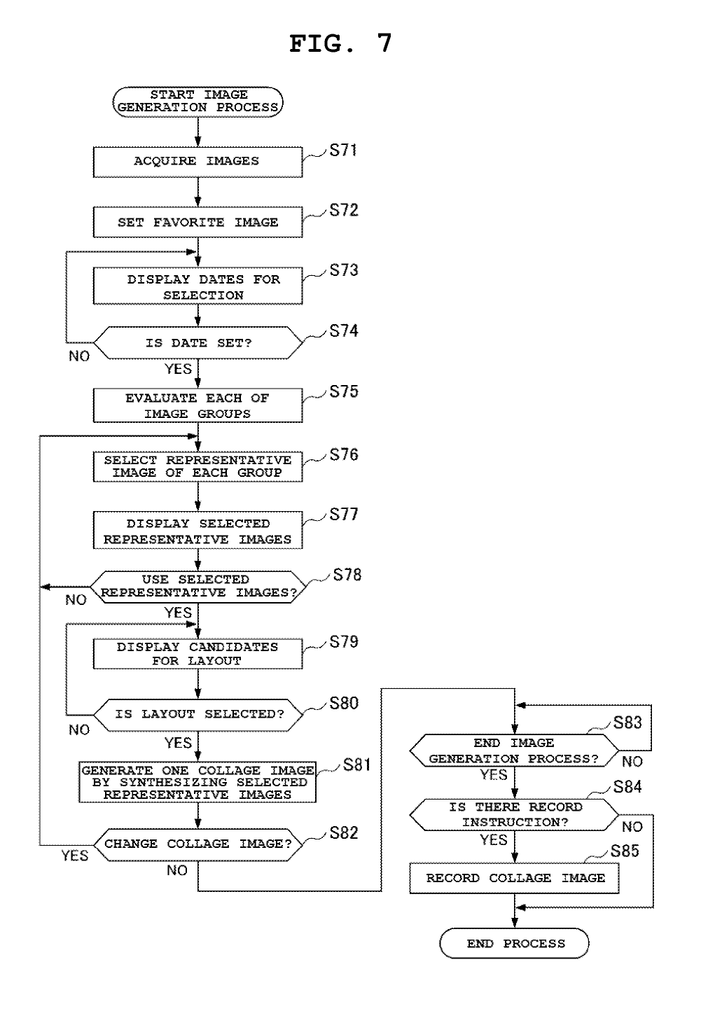

FIG. 7 is a flow chart for explaining an image generation process according to the third embodiment of the present invention.

At Step S71, the image acquiring unit 51 acquires images from the imaging unit 16 or the outside. The acquired images are stored in the image storage unit 71.

At Step S72, the image setting unit 52 sets each of the images stored in the image storage unit 71 to [FAVORITE], [UNFAVORITE] or [OTHERS] according to operations input by the user to the input unit 17.

At Step S73, the images setting unit 52 sets a date for image selection from a plurality of candidates (i.e. a plurality of dates). More specifically, referring to the shooting date and time of the supplementary information stored in a predetermined information area (for example, EXIF (Exchangeable image file format) area) of each of a plurality of still images captured already, the image setting unit 52 displays a list of shooting dates.

At Step S74, the image setting unit 52 determines whether or not a specific date is set from the displayed list of dates by an operation input by the user to the input unit 17.

In the case that a specific date is not set, the determination at Step S74 is “NO” and the process returns to Step S73.

In the case that a specific date is set, the determination at Step S74 is “YES” and the process proceeds to Step S75.

At Step S75, the image evaluating unit 53 evaluates each of image groups into which a set of images shot on the set specific date are divided. More specifically, the image evaluating unit 53 evaluates images included in each of groups divided by predetermined time periods (for example, time slots such as from 6 to 9 o′clock, from 10 to 13 o′clock, from 14 to 17 o′clock, from 17 to 20 o′clock, and the like) of the set date.

At Step S76, the image selecting unit 54 selects a representative image of every group based on the evaluation by the image evaluating unit 53.

At Step S77, the output control unit 56 controls the output unit 18 to display the selected representative images. As a result, the output unit 18 displays the selected representative images so that the user can determine whether or not to generate a collage image using the representative images.

At Step S78, the image selecting unit 54 determines whether or not to generate a collage image using the selected representative images by an operation input by the user to the input unit 17.

In the case that a collage image is not generated using the selected representative images, the determination at Step S78 is “NO” and the process returns to Step S76. Then, reselection of representative images is performed at Step S76 by selecting the second highest scoring images, for example.

In the case that a collage image is generated using the selected representative images, the determination at Step S78 is “YES” and the process proceeds to Step S79.

At Step S79, the output control unit 56 controls the output unit 18 to display the selectable layout candidates stored in the effect information storage unit 73. As a result, the output unit 18 displays each of the layouts so that the user can determine which layout to select for the collage image. Then, the effect selecting unit 57 selects one of the layouts stored in the effect information storage unit 73 based on an instruction input by the user to the input unit 17.

At Step S80, the effect selecting unit 57 determines whether or not a layout is selected by an operation input by the user to the input unit 17.

In the case that no layout is selected, the determination at Step S80 is “NO” and the process returns to Step S79.

In the case that a layout is selected, the determination at Step S80 is “YES” and the process returns to Step S81.

At Step S81, the image generating unit 55 generates one collage image by synthesizing the plurality of selected representative images according to the layout.

At Step S82, the image selecting unit 54 determines whether or not an instruction to change the collage image is input from the input unit 17 or the like.

In the case that there is the instruction to change the collage image, the determination at Step S82 is “YES” and the process returns to Step S76.

In the case that there is no instruction to change the collage image, the determination at Step S82 is “NO” and the process proceeds to Step S83.

At Step S83, the image generating unit 55 determines whether or not to end the image generation process, for example, by an operation to end the image generation process input by the user to the input unit 17.

In the case that it is determined not to end the image generation process, the determination at Step S83 is “NO” and the process stands by.

In the case that it is determined to end the image generation process, the determination at Step S83 is “YES” and the process proceeds to Step S84.

At Step S84, the image generating unit 55 whether or not there is a record instruction, for example, an operation to instruct to record the collage image input by the user to the input unit 17.

In the case that there is no record instruction, the determination at Step S84 is “NO” and the image generation process is ended.

In the case that there is the record instruction, the determination at Step S84 is “YES” and the process proceeds to

Step S85.

At Step S85, the image generating unit 55 records the generated collage image in the image storage unit 71. After that, the image generation process is ended.

The record of the generated collage image in the image storage unit 71 is not limited to the case where there is no instruction of change as described above. In another embodiment, whenever there is an instruction of change, the image generating unit 55 records every generated collage image in the image storage unit 71.

Therefore, the imaging apparatus 1 of the embodiments of the present invention can automatically select images and generate a collage image into which pleasant moments are condensed just by the user's selection of a date of shooting the images and a layout. Further, according to the imaging apparatus 1 of some embodiments, an image automatically selected may be reselected by manipulation of one touch and the user's favorite images may be selected by priority.

### Fourth Embodiment

According to a fourth embodiment of the present embodiment, a digest moving picture is generated based on representative still pictures/representative moving pictures (hereinafter, briefly referred to as “representative images”) selected from groups of still pictures/groups of moving pictures of a predetermined date. Further, according to the present embodiment, an effect is added to a part of the selected representative images based on evaluation. For example, the effect can be zooming or panning of images of the same content among the representative images. Furthermore, a user may select BGM (Background Music) or a length of the digest moving picture according to purposes.

With respect to the present embodiment, descriptions of features common to the above described embodiments (the hardware configuration and the functional configuration for executing the image generation process) are omitted.

In the image storage unit 71, there are stored moving pictures as well as still pictures acquired from the imaging unit 16 or the outside.

In the effect information storage unit 73, there are stored some kinds of BGM (in the present embodiment, four kinds of BGM), lengths of a digest moving picture to be generated (in the present embodiment, three kinds of length, i.e. 30 seconds, 1 minute, and 3 minutes), and information of effects in images.

The image setting unit 52 sets the BGM (in the present embodiment, one of the four kinds of BGM) and the length of a digest moving picture (in the present embodiment, one of the three kinds of length, i.e. 30 seconds, 1 minute, and 3 minutes).

The image selecting unit 54 selects images of the number corresponding to the set length of the digest moving picture from groups of images as representative images based on evaluation for each of the images (each still picture/moving picture) executed by the image evaluating unit 53.

The effect selecting unit 57 selects an effect such as zooming, panning, or the like, for images of the same content from the information of effects stored in the effect information storage unit 73 based on the evaluation for the selected representative images (representative still pictures/moving pictures). More specifically, the effect selecting unit 57 selects an effect to be added to a representative image receiving the highest evaluation, for example. Further, the effect selecting unit 57 may select an effect to be applied between two images (a so-called transition effect) or an effect of changing the order of display based on the evaluation for the selected representative still pictures/representative moving pictures.

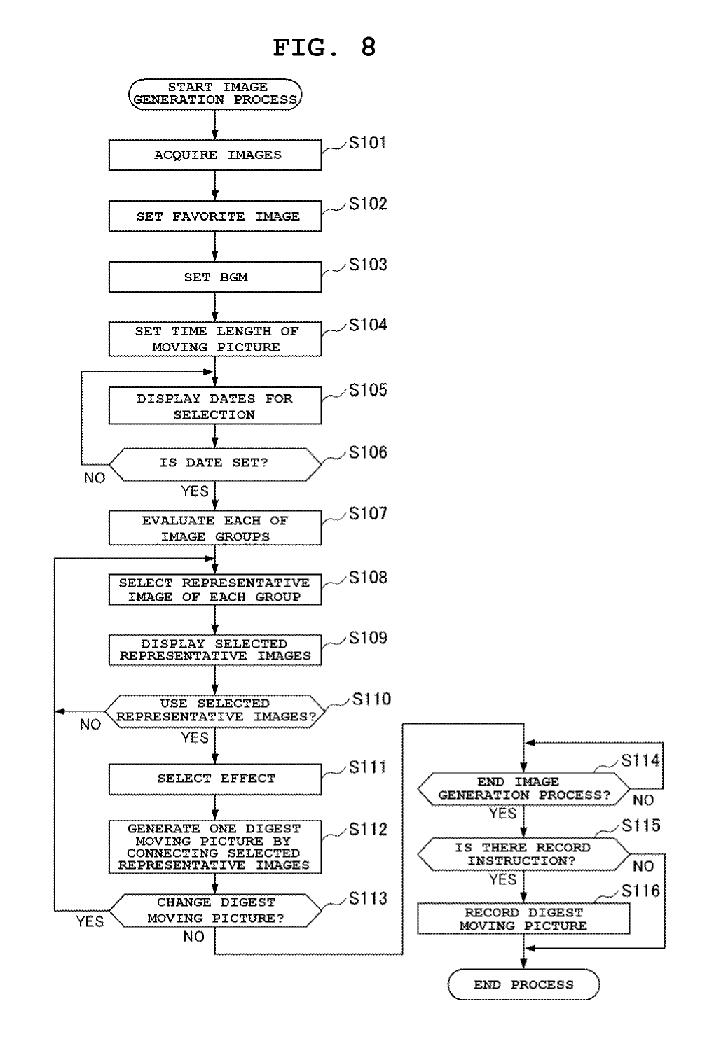

FIG. 8 is a flow chart for explaining an image generation process according to the fourth embodiment of the present invention.

At Step S101, the image acquiring unit 51 acquires images from the imaging unit 16 or the outside. The acquired images (still pictures and moving pictures) are stored in the image storage unit 71.

At Step S102, the image setting unit 52 sets each of the images stored in the image storage unit 71 to [FAVORITE], [UNFAVORITE] or [OTHERS] according to operations input by the user to the input unit 17.

At Step S103, the image setting unit 52 sets BGM to be added to a digest moving picture. More specifically, the image setting unit 52 selects one kind of BGM from the four kinds of

BGM stored in the effect information storage unit 73 according to a setting operation input by the user to the input unit 17. For this, the output control unit 56 controls the output unit 18 to display titles of the BGM and the like in order to facilitate the user's selection.

At Step S104, the image setting unit 52 sets a length of the moving picture. More specifically, the image setting unit 52 select one of the three kinds of length stored in the effect information storage unit 73 (in the present embodiment, one of 30 seconds, 1 minute, and 3 minutes) according to a setting operation input by the user to the input unit 17. For this, the output control unit 56 controls the output unit 18 to display information of the selectable lengths of the digest moving picture so that the user can select one of them.

At Step S105, the images setting unit 52 sets a date for image selection from a plurality of candidates (i.e. a plurality of dates). More specifically, referring to the supplementary information of a plurality of images captured already, the image setting unit 52 displays a list of shooting dates of the plurality of images.

At Step S106, the image setting unit 52 determines whether or not a specific date is set from the displayed list of dates by an operation input by the user to the input unit 17.

In the case that a specific date is not set, the determination at Step S106 is “NO” and the process returns to Step S105.

In the case that a specific date is set, the determination at Step S106 is “YES” and the process proceeds to Step S107.

At Step S107, the image evaluating unit 53 evaluates each of image groups into which a set of images (still pictures and moving pictures) shot on the set specific date are divided. More specifically, the image evaluating unit 53 evaluates still images and/or moving pictures included in each of groups divided by predetermined time periods (for example, time slots such as from 6 to 9 o′clock, from 10 to 13 o′clock, from 14 to 17 o′clock, from 17 to 20 o′clock, and the like) of the set date.

At Step S108, the image selecting unit 54 selects images of the number corresponding to the set length of the digest moving picture from the groups as representative images based on the evaluation for each image (each still picture/each moving picture) by the image evaluating unit 53.

At Step S109, the output control unit 56 controls the output unit 18 to display the selected representative images (representative still pictures and representative moving pictures). As a result, the output unit 18 displays the selected representative images so that the user can determine whether or not to generate a moving picture using the representative images.

At Step S110, the image selecting unit 54 determines whether or not to generate a digest moving picture using the selected representative images by an operation input by the user to the input unit 17.

In the case that a collage image is not generated using the selected representative images, the determination at Step S110 is “NO” and the process returns to Step S108. Then, reselection of representative images (representative still pictures and representative moving pictures) is performed at Step S108 by selecting the second highest scoring images, for example.

In the case that a collage image is generated using the selected representative images, the determination at Step S110 is “YES” and the process proceeds to Step S111.

At Step S111, the effect selecting unit 57 selects an effect such as zooming, panning, or the like, for images of the same content from the information of effects stored in the effect information storage unit 73 based on the evaluation for the selected representative images (the representative still pictures/moving pictures). More specifically, the effect selecting unit 57 selects an effect to be added to a representative image getting the highest evaluation, for example.

At Step S112, the image generating unit 55 generates one digest moving picture by connecting the selected representative images (the representative still pictures/moving pictures) and adding the set BGM. Further, the image generating unit 55 applies the selected effect to a corresponding part of a predetermined representative image based on the evaluation of the representative images (the representative still pictures/moving pictures).

At Step S113, the image selecting unit 54 determines whether or not an instruction to change the digest moving picture is input from the input unit 17 or the like.

In the case that there is the instruction to change the collage image, the determination at Step S113 is “YES” and the process returns to Step S108.

In the case that there is no instruction to change the collage image, the determination at Step S113 is “NO” and the process proceeds to Step S114.

At Step S114, the image generating unit 55 determines whether or not to end the image generation process, for example, by an operation to end the image generation process input by the user to the input unit 17.

In the case that it is determined not to end the image generation process, the determination at Step S114 is “NO” and the process stands by.

In the case that it is determined to end the image generation process, the determination at Step S114 is “YES” and the process proceeds to Step S115.

At Step S115, the image generating unit 55 whether or not there is a record instruction, for example, an operation to instruct to record the digest moving picture input by the user to the input unit 17.

In the case that there is no record instruction, the determination at Step S115 is “NO” and the image generation process is ended.

In the case that there is the record instruction, the determination at Step S115 is “YES” and the process proceeds to Step S116.

At Step S116, the image generating unit 55 records the generated digest moving picture in the image storage unit 71. After that, the image generation process is ended.

The record of the generated digest moving picture in the image storage unit 71 is not limited to the case where there is no instruction of change as described above. In another embodiment, whenever there is an instruction of change, the image generating unit 55 records every generated moving picture in the image storage unit 71.

In addition, the image generation process is configured to select images receiving particularly high evaluation, sort the remaining images, divide the images into groups by a predetermined number (for example, five) in descending order of shooting time, select representative images corresponding to the rest of the target playback time, and generates a composite image using the selected representative images.

Therefore, the imaging apparatus 1 of the embodiments of the present invention can generate one digest moving picture to which an effect is automatically added just by the user's selection of a date of shooting the images. Further, according to the imaging apparatus 1 of some embodiments, the user can select BGM to be added to a moving picture or a length of the moving picture.

### Fifth Embodiment

According to a fifth embodiment of the present invention, a kind of images to be used (only still pictures/only moving pictures/both of still and moving pictures) can be selected.

In the above described embodiment, the image generation process is configured to select images receiving particularly high evaluation, sort the remaining images, divide the images into groups by a predetermined number (for example, five) in descending order of shooting time, select representative images corresponding to the rest of the target playback time, and generates a composite image using the selected representative images. According to this configuration, images shot relatively late are not selected. On the other hand, in the present embodiment, representative images can be selected from all the images by dividing the remaining images by (the rest of the target playback time)/(playback time of one piece of image).

Further, the present embodiment is configured not to select images shot vertically, image shot by a special method such as a time-lapse image, and to which a special effect is added.

In the present embodiment, a process of selecting images (hereinafter, referred as to an “image selection process”) is executed by performing steps described in the following.

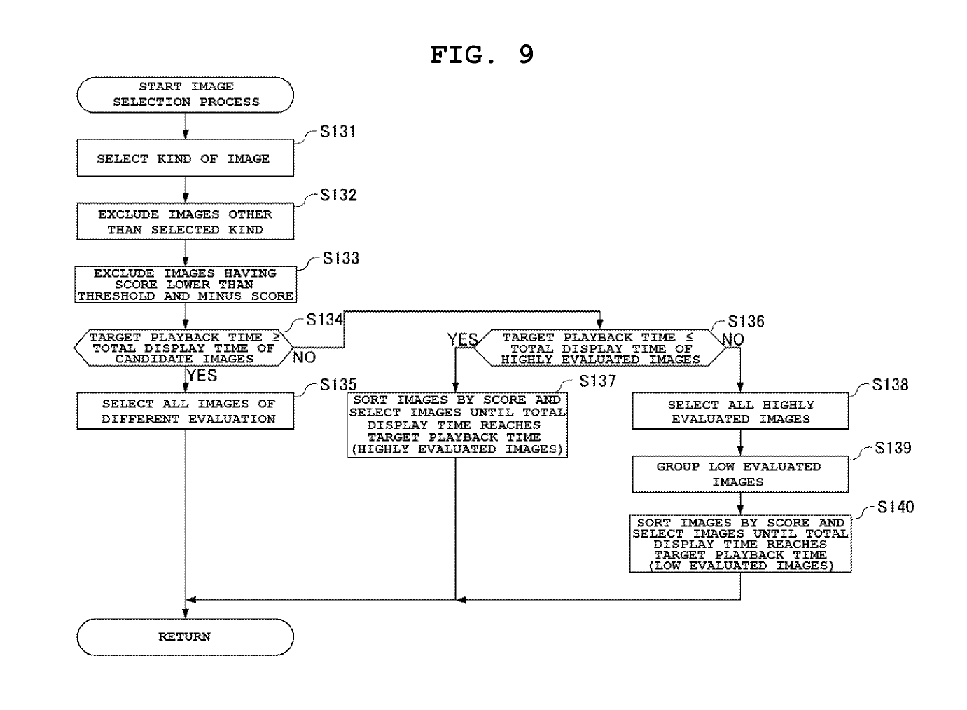

FIG. 9 is a flow chart for explaining the image selection process according to the fifth embodiment of the present invention.

At Step S131, a kind of images to be used is selected by a select operation input by a user to the input unit 17.

The image selecting unit 54 sorts images shot on the selected date among images of the selected kind (only still pictures/only moving pictures/both of still and moving pictures) in order of update time. Here, the update time of an image means time when the file of the image is updated and includes dates when the image is shot and the file is read. The sort in order of update time means sorting images so that the file image of which update time is the closest to the present is at the top.

At Step S132, the image selecting unit 54 excludes any images other than those of the selected kind from selection according to the setting.

At Step S133, the image selecting unit 54 excludes images scoring lower than a threshold and receiving minus evaluation. In the present embodiment, the images receiving minus evaluation include images of the vertical direction, i.e. a degree of 90° or 270° and a digest image.

At Step S134, the image selecting unit 54 determines whether or not the sum of display time of images other than the excluded images, i.e. images receiving high scores (hereinafter, referred to as “highly evaluated images”) and no scores (hereinafter, referred to as “low evaluated images”) is shorter than or equal to a set time (a target playback time≧the total display time of selection candidate images).

In the case that the sum of display time of the images receiving different evaluation (i.e. the images other than the excluded images) is shorter than or equal to the set time, the determination at Step S134 is “YES” and the process proceeds to Step S135.

At Step S135, the image selecting unit 54 selects all of the images other than the excluded images. At this step, the image selecting unit 54 sorts the selected images by the update time for image generation. After that, the image selection process is ended and an image generation process is started.

On the other hand, in the case that the total display time of the images receiving different evaluation is longer than the set time, the determination at Step S134 is “NO” and the process proceeds to Step S136.

At Step S136, the image selecting unit 54 determines whether or not the sum of display time of the highly evaluated images is longer than or equal to the target playback time (the target playback time <the total display time of the highly evaluated images).

In the case that the total display time of the highly evaluated images is longer than or equal to the target playback time, the determination at Step S136 is “YES” and the process proceeds to Step S137.

At Step S137, the image selecting unit 54 sorts the highly evaluated images by the score and selects images in descending order of the score until the total display time of the selected images reaches the target playback time. In the case that there are images of the same score, the image selecting unit 54 selects images in descending order of the update time. For this, the image selecting unit 54 sorts and selects the images for composite image generation by the update time. After that, the image selection process is ended and an image generation process is started.

On the other hand, in the case that the total display time of the highly evaluated images is shorter than the target playback time, the determination at Step S136 is “NO” and the process proceeds to Step S138.

At Step S138, the image selecting unit 54 selects all if the highly evaluated images.

At Step S139, the image selecting unit 54 sorts and groups the low evaluated images by the update time. The number of groups is determined as (the target playback time-the total display time of the highly evaluated images)/5 [decimals are raised to the next whole number], for example. The low evaluated images are evenly divided into groups of the determined number in order of update time.

At Step S140, the image selecting unit 54 sorts low evaluated images of every group by the score and selects images from every group in descending order of the score until the sum of display time of the selected images reaches the rest of the target playback time (the target playback time-the total display time of the highly evaluated images). After that, the image selection process is ended and an image generation process is started.

The imaging apparatus 1 as configured above according to the embodiments includes the image acquiring unit 51, the image setting unit 52, the image selecting unit 54, and the image generating unit 55.

The image acquiring unit 51 acquires a plurality of images belonging to different groups.

The image setting unit 52 determines the number of images to be used for generation of a new image.

The image selecting unit 54 selects images of the number determined by the image setting unit 52 from the different groups based on supplementary information of the images acquired by the image acquiring unit 51.

The image generating unit 55 generates a new image from the plurality of images selected by the image selecting unit 54.

Therefore, the imaging apparatus 1 of the embodiments reduces the burden of selecting images from a plurality of images to generate a composite image.

Further, the imaging apparatus 1 of the embodiments includes the image evaluating unit 53 for evaluating supplementary information of each of the plurality of images belonging to the different groups.

According to certain embodiments, the image selecting unit 54 selects one or more images from each of the different groups based on the evaluation executed by the image evaluating unit 53.

By this, according to the imaging apparatus 1 of the embodiments, it is possible to select images which the user wants to use as component images for generation of a new image.

According to certain embodiments, the image selecting unit 54 selects an image which has a predetermined ranking of evaluation by an evaluation means in each of the different groups.

By this, according to the imaging apparatus 1 of the embodiments, it is possible to select images which the user wants to use as component images for generation of a new image.

According to certain embodiments, the image selecting unit 54 selects a plurality of images from each of the different groups.

By this, according to the imaging apparatus 1 of the embodiments, it is possible to select images which the user wants to use as component images for generation of a new image.

According to certain embodiments, the image selecting unit 54 selects, from each of the different groups, images of the number smaller than the total number of images belonging to the group.

By this, according to the imaging apparatus 1 of the embodiments, it is possible to select images which the user wants to use as component images for generation of a new image.

According to certain embodiments, the image selecting unit 54 selects an image which has a predetermined ranking of the evaluation by the image evaluating unit 53 in each of the different groups.

By this, according to the imaging apparatus 1 of the embodiments, it is possible to select images which the user wants to use as component images for generation of a new image.

According to certain embodiments, the image selecting unit 54 selects a specific group from the different groups.

Further, the image selecting unit 54 changes methods for selecting images between the selected specific group and any group other than the selected specific group.

By this, according to the imaging apparatus 1 of the embodiments, it is possible to select images which the user wants to use as component images for generation of a new image.

According to certain embodiments, the image selecting unit 54 selects an image which has a predetermined ranking of the evaluation by the image evaluating unit 53 in the specific group and randomly selects an image in any group other than the specific group.

By this, according to the imaging apparatus 1 of the embodiments, it is possible to select images which the user wants to use as component images for generation of a new image.

According to certain embodiments, the image selecting unit 54 divides a plurality of images into different groups.

The image acquiring unit 51 acquires the plurality of images divided into the different groups by the image selecting unit 54.

By this, according to the imaging apparatus 1 of the embodiments, it is possible to handle the images group by group and select images which the user wants to use as component images for generation of a new image.

According to certain embodiments, the image selecting unit 54 divides a plurality of images into different groups of the number corresponding to the number of images determined by the image setting unit 52.

By dividing a plurality of images into different groups of the number corresponding to the determined number of images, the imaging apparatus 1 of the embodiments divides and selecting images from each of the groups, the imaging apparatus 1 of the embodiments can generate a new image of diversity because different images are selected.

According to certain embodiments, the imaging apparatus 1 includes the image setting unit 52 for setting a specific time period from a plurality of time periods.

The image acquiring unit 51 acquires a plurality of images belonging to each of different groups corresponding to the set time period.

By this, according to the imaging apparatus 1 of the embodiments, it is possible to select images which the user wants to use as component images for generation of a new image.

The different groups are divided by a specific time unit selected from a group comprising a predetermined number of days, weeks, months, seasons, and years, and a predetermined time period of a specific calendar.

By this, according to the imaging apparatus 1 of the embodiments, it is possible to generate a new image for events of every specific days, every specific weeks, every specific months, every specific years, or every specific time period of a specific calendar.

According to certain embodiments, the image generating unit 55 generates one piece of image in which the plurality of selected images are disposed as the new image.

By this, according to the imaging apparatus 1 of the embodiments, it is possible to generate a collage image which the user wants automatically.

According to certain embodiments, the imaging apparatus 1 determines arrangement of the plurality of selected images in one image based on a layout setting positions and sizes of the images beforehand.

Therefore, according to the imaging apparatus 1 of the embodiments, the user can easily imagine a final collage image.

According to certain embodiments, the image selecting unit 54 selects moving pictures and/or still pictures from the plurality of images belonging to the different groups.

By this, according to the imaging apparatus 1 of the embodiments, it is possible to generate a new image using moving pictures and/or still pictures.

According to certain embodiments, the image selecting unit 54 selects moving pictures and/or still pictures from a plurality of images belonging to a specific group.

By this, according to the imaging apparatus 1 of the embodiments, it is possible to generate a new image using moving pictures and/or still pictures.

According to certain embodiments, the image setting unit 52 sets playback time for each image of a plurality of images belonging to the different groups for generation of a moving picture.

Further, the image setting unit 52 determines the number of images to be used for generation of a new moving picture based on the set playback time.

Since the number of images to be used for generation of a new moving picture is determined based on the set playback time according to the imaging apparatus 1 of the embodiments, it is possible to generate a moving picture of playback time which the user chooses.

According to certain embodiments, the image generating unit 55 generates a moving picture by connecting the plurality of selected images as a new image.

By this, according to the imaging apparatus 1 of the embodiments, it is possible to automatically generate a moving picture consisting of a plurality of images which the user wants to use.

According to certain embodiments, the image generating unit 55 applies an effect based on the selected images.

By this, according to the imaging apparatus 1 of the embodiments, an effect is applied to an image receiving high evaluation, for example. Therefore, it is possible to apply visual effects to images which the user prefers thereby automatically generating an effective moving picture consisting of a plurality of images which the user wants to use.

According to certain embodiments, the image setting unit 52 determines the number of images to be used for generation of a new image based on the user's operation.

By this, according to the imaging apparatus 1 of the embodiments, it is possible to set the number of images to a number which the user chooses.

In addition, the present invention is not limited to the embodiments described above and various modifications and alternatives which can achieve the object of the invention fall within the scope of the present invention.

The above embodiments use shooting information when evaluating images but the present invention is not limited to these embodiments. An embodiment of the present invention can be configured to score the images by determining the user's taste from the view of the number of view, image protection, or the like.

Further, according to some embodiments, a time limit can be set so that only images before or after a specific date are selected. Further, some embodiments can be configured to select only images of a specific time unit such as a day, a week, a month, a year, a date, a year, a season, or a time period of a specific calendar. Further, a plurality of days other than the specific time period such as a day, a week or a month may be selected. Alternatively, a plurality of days, a plurality of time slots, or a time period of different time units (for example, a combination of days and weeks) may be selected.

Further, the embodiments described above have been described mainly with respect to still pictures as images for selection but moving pictures may be images for selection. In this case, a frame image corresponding to a scene for which a special operation such as zooming is performed or a representative scene may be adopted as an image to be used for generation of a new image.

Further, some of the embodiments described above are configured to use shooting information for selection of images but the present invention is not limited to this configuration. For example, the number of view or time of viewing of an image in which the user is likely interested may be a condition of evaluation (scoring). More specifically, in the case that the time of viewing an image is long, some points are added to the score of the image. In the case that an operation such as zooming is performed when viewing an image, some points are subtracted from the score of the image. In the case that a moving picture is not played to the end or is fast-forwarded, some points are subtracted from the score of the moving picture.

Further, the imaging apparatus 1 may not only count the number or time of display but also perform detection of eyes or a posture of itself to determine a time period during which the user's eyes are on an image or whether or not a posture of the imaging apparatus 1 is correct while displaying the image in order to count the substantial number of display or substantial time of viewing of the image.

Further, in addition to the criteria of evaluation of the embodiments described above, content of an image can be a criterion of evaluation. For example, in the case that a smiling face is detected from an image, the image is regarded as a pleasant scene and highly evaluated. As a result, it is possible to generate a collage image collecting only pleasant time.

Further, although the image selection of the above embodiments has been described with respect to generation of a collage image or a moving picture, it can also be used for playback of a slide show. Further, according to another embodiment, ex post edition including selection of images can be performed to a newly generated image.

Further, in the embodiments described above, the present invention has been applied to a digital camera as an example of the imaging apparatus 1 without limitation.

For example, the present invention can be applied to general electronic devices having a function of image generation. Specifically, the present invention can be applied to a notebook type personal computer, a printer, a television, a video camera, a portable navigation device, a mobile phone, a smart phone, a portable game device, and the like.

The process sequence described above can be executed by hardware or software.

In other words, the functional configurations shown in FIGS. 3 and 6 are merely examples and the present invention is not limited thereto. The imaging apparatus 1 suffices if it has a function for performing the process sequence as a whole. Functional blocks to use to implement this function are not limited to the embodiments of FIGS. 3 and 6.

In addition, a functional block may be configured by a piece of hardware, a piece of software, or their combination.

In the case that the sequence is performed by software, a program configuring the software is installed in a computer or the like from a network or a storage medium.

The computer may be a computer which is incorporated in dedicated hardware. In addition, the computer may be a computer capable of executing various functions by installing various programs therein, for example, a general-purpose personal computer.

A storage medium for recording such a program consists of not only the removable media 31 shown in FIG. 1 which is distributed separately from the apparatus's main body to provide it to users, but also a storage medium or the like which is provided to users in a state of being incorporated in the apparatus's main body in advance. The removable media 31 includes, for example, a magnetic disk (including a floppy disk), an optical disc, a magneto-optical disk, or the like. For example, the optical disc includes a compact disk-read only memory (CD-ROM), a digital versatile disk (DVD), a Blu-ray (Registered Trademark) disc, or the like. The magneto-optical disk includes a Mini-Disk (MD), or the like. In addition, the storage medium which is provided to the users in a state of being incorporated in the apparatus's main body in advance includes, for example, the ROM 12 in FIG. 1 in which a program is recorded, a hard disk included in the storage unit 19 in FIG. 1, or the like.

Further, in the description presented here, the steps describing a program recorded in a recording medium include not only processes to be executed serially in time in order, but also processes which are not necessarily executed serially in time but in a parallel manner or individually.

Although some embodiments of the present invention have been described above, the embodiments are for illustrative purposes only and not intended to limit the technical scope of the present invention. It will be evident that there are many other possible embodiments of the present invention and various modifications such as omission or substitution may be made without departing from the spirit of the invention. These embodiments and modifications fall within the scope and the spirit of the invention described in this specification and within the scope of the invention as defined in the appended claims and equivalents thereof.

What is claimed is:

1. An image generating apparatus comprising:
an image acquiring section configured to acquire a plurality of images belonging to different groups;
an image number determining section configured to determine the number of images to be used for generation of a new image;
an image selecting section configured to select images of the number determined by the image number determining section from the plurality of images belonging to the different groups acquired by the image acquiring section based on supplementary information of the plurality of images acquired by the image acquiring section; and
a generating section configured to generate a new image from a plurality of images selected by the image selecting section.

2. The image generating apparatus of claim 1 further comprising an evaluating section configured to evaluate supplementary information of each of the plurality of images belonging to the different groups,
wherein the image selecting section selects an image from each of the different groups based on the evaluation by the evaluating section.

3. The image generating apparatus of claim 2, wherein the image selecting section selects an image which has a predetermined ranking of the evaluation by the evaluating section in each of the different groups.

4. The image generating apparatus of claim 1, wherein the image selecting section selects the plurality of images from each of the different groups.

5. The image generating apparatus of claim 1, wherein the image selecting section selects, from each of the different groups, images of the number smaller than the total number of a plurality of images belonging to the group.

6. The image generating apparatus of claim 2 further comprising a group selecting section configured to select a specific group from the different groups,
wherein the image selecting section changes methods for selecting images between the specific group selected by the group selecting section and any group other than the selected specific group.

7. The image generating apparatus of claim 6, wherein the image selecting section selects an image which has a predetermined ranking of the evaluation by the evaluating section in the specific group, and randomly selects an image in any group other than the specific group of the different groups.

8. The image generating apparatus of claim 1 further comprising a dividing section configured to divide a plurality of images into different groups,
wherein the image acquiring section acquires a plurality of images divided into different groups by the dividing section.

9. The image generating apparatus of claim 8, wherein the dividing section divides a plurality of images into different groups of the number corresponding to the number of images determined by the image number determining section.

10. The image generating apparatus of claim 1 further comprising a time period setting section configured to set a specific time period from a plurality of time periods,
wherein the image acquiring section acquires a plurality of images belonging to different groups corresponding to the time period set by the time period setting section.

11. The image generating apparatus of claim 1, wherein the different groups are divided by a predetermined time unit selected from a group comprising a predetermined number of days, weeks, months, seasons, and years, and a predetermined time period of a specific calendar.

12. The image generating apparatus of claim 1, wherein the generating section generates one image in which the plurality of images selected by the image selecting section are disposed as the new image.

13. The image generating apparatus of claim 12, wherein the disposition of the plurality of selected images in one image is determined based on a layout for setting positions and sizes of the images beforehand.

14. The image generating apparatus of claim 1, wherein the image selecting section selects at least one of a moving picture and a still picture from the plurality of images belonging to the different groups.

15. The image generating apparatus of claim 6, wherein the image selecting section selects at least one of a moving picture and a still picture from a plurality of images belonging to the specific group.

16. The image generating apparatus of claim 2 further comprising a playback time setting section configured to set playback time for generation of a moving picture for each of a plurality of images belonging to each of the different groups based on the evaluation by the evaluating section,
wherein the image number determining section determines the number of images to be used for generation of a new moving picture based on the playback time set by the playback time setting section.

17. The image generating apparatus of claim 1, wherein the generating section generates a moving picture as the new image by connecting the plurality of selected images.

18. The image generating apparatus of claim 17, wherein the generating section applies an effect to the new image based on the selected images.

19. The image generating apparatus of claim 1, wherein the image number determining section determines the number of images to be used for generation of a new image based on a user's operation.

20. An image generating method comprising:
an image acquiring step of acquiring a plurality of images belonging to different groups;
an image number determining step of determining the number of images to be used for generation of a new image;
an image selecting step of selecting images of the number determined at the image number determining step from the plurality of images belonging to the different groups acquired at the image acquiring step based on supplementary information of the plurality of images acquired at the image acquiring step; and
a generating step of generating a new image from a plurality of images selected at the image selecting step.

21. A non-transitory computer-readable recording medium for recording a program readable by a computer, the program controlling the computer to function as:
an image acquiring section configured to acquire a plurality of images belonging to different groups;
an image number determining section configured to determine the number of images to be used for generation of a new image;
an image selecting section configured to select images of the number determined by the image number determining section from the plurality of images belonging to the different groups acquired by the image acquiring section based on supplementary information of the plurality of images acquired by the image acquiring section; and
a generating section configured to generate a new image from a plurality of images selected by the image selecting section.
